(19) United States
(12) Patent Application Publication
(10) Pub. No.: US 2024/0253190 A1
(43) Pub. Date: Aug. 1, 2024

(54) BIT HOLDING DEVICE

(71) Applicant: MILWAUKEE ELECTRIC TOOL CORPORATION, Brookfield, WI (US)

(72) Inventor: Devin C. Albrecht, Hartford, WI (US)

(21) Appl. No.: 18/560,618

(22) PCT Filed: May 13, 2022
(86) PCT No.: PCT/US2022/029206

§ 371 Date: Nov. 13, 2023

Related U.S. Application Data
(60) Provisional application No. 63/188,543, filed on May 14, 2021.

(51) Int. Cl. B25B 23/00; B25B 21/02

(52) U.S. Cl. CPC B25B 23/0035; B25B 21/02

(57) ABSTRACT

A bit holder for retaining a tool bit having a groove includes a body defining a bore for receiving the tool bit. The bore includes a first plurality of edges corresponding to an outer profile of the tool bit. The bit holder also includes a collar movably coupled to the body and a lock ring supported within the collar. The lock ring includes an opening having a second plurality of edges, and the lock ring is rotatable between a locked position in which the second plurality of edges is misaligned with the first plurality of edges and an unlocked position in which the second plurality of edges is aligned with the first plurality of edges. The lock ring is rotatable from the locked position toward the unlocked position in response to a rear end of the tool bit engaging the lock ring.

### CROSS-REFERENCE TO RELATED APPLICATIONS

This application claims priority to U.S. Provisional Patent Application No. 63/188,543, filed May 14, 2021, the entire contents of which are incorporated herein by reference.

### FIELD

The present disclosure relates to bit holding devices. More particularly, the present disclosure relates to bit holding devices for coupling interchangeable tool bits to power tools.

### BACKGROUND

Power tools in general, and more specifically rotary power tools, typically include bit holding devices to allow the power tool to be used with any number of interchangeable tool bits. Such tool bit devices usually require two hands to change a tool bit, one hand to pull back on a collar of the bit holding device, and the other hand to insert/remove the tool bit from a bore. However, if a user is repeatedly changing tool bits, this two-handed action can be slow and inefficient.

### SUMMARY

One embodiment of the present disclosure provides a bit holder for retaining a tool bit having a groove. The bit holder includes a body defining a bore for receiving the tool bit. The bore includes a first plurality of edges corresponding to an outer profile of the tool bit. The bit holder also includes a collar movably coupled to the body and a lock ring supported within the collar. The lock ring includes an opening having a second plurality of edges, and the lock ring is rotatable between a locked position in which the second plurality of edges is misaligned with the first plurality of edges and an unlocked position in which the second plurality of edges is aligned with the first plurality of edges. The lock ring is rotatable from the locked position toward the unlocked position in response to a rear end of the tool bit engaging the lock ring.

In some embodiments, the second plurality of edges defines a spiral spline.

In some embodiments, a spring is configured to bias the lock ring toward the locked position.

In some embodiments, the collar is movable along the body to move the lock ring toward the unlocked position.

In some embodiments, the rear end of the tool bit is insertable into the bore when the lock ring is in the unlocked position, and the lock ring is movable from the unlocked position toward the locked position when the groove of the tool bit aligns with the lock ring to retain the tool bit within the bore.

In some embodiments, insertion of the tool bit into the bore and retention of the tool bit by the lock ring can be accomplished in a single motion with one hand.

Another embodiment of the present disclosure provides, a rotary impact tool including a housing, an electric motor supported in the housing, a drive assembly for converting a continuous torque input from the motor to consecutive rotational impacts upon a workpiece, the drive assembly including an anvil having a bit holder for selectively coupling a tool bit to the anvil. The bit holder includes a body defining a bore for receiving the tool bit, the bore including a first plurality of edges corresponding to an outer profile of the tool bit, a collar movably coupled to the body, and a lock ring supported within the collar. The lock ring includes an opening having a second plurality of edges, and the lock ring is rotatable between a locked position in which the second plurality of edges is misaligned with the first plurality of edges and an unlocked position in which the second plurality of edges is aligned with the first plurality of edges. The lock ring is rotatable from the locked position toward the unlocked position in response to a rear end of the tool bit engaging the lock ring.

In some embodiments, the body includes a plurality of L-shaped grooves.

In some embodiments, the lock ring includes a plurality of posts radially extending from the lock ring and received within the L-shaped grooves.

In some embodiments, the lock ring is biased toward the locked position, in which the posts are constrained from moving radially with respect to the L-shaped grooves.

In some embodiments, while in the unlocked position, the posts are configured to move radially with respect to the L-shaped grooves.

In some embodiments, one of the first plurality of edges and the second plurality of edges defines a hexagonal cross-section and extends in an axial direction.

In some embodiments, the other one of the first plurality of edges and the second plurality of edges defines a hexagonal cross-section and extends in an spiral direction offset relative to the axial direction.

In some embodiments, the other one of the first plurality of edges and the second plurality of edges are the second plurality of edge positioned on the lock ring, such that the lock ring is configured to rotate relative to the body and to the tool bit.

In some embodiments, insertion of the tool bit into the bore and retention of the tool bit by the lock ring can be accomplished in a single motion with one hand.

Another embodiment of the present disclosure provides rotary impact tool including a housing, an electric motor supported in the housing, an impact mechanism including an anvil and a hammer configured to repeatedly strike the anvil, and a bit holder supported by the impact mechanism and including a lock ring configured to selectively retain a tool bit to the impact mechanism, the tool bit having a non-hexagonal groove portion formed in a hexagonal body portion, and the lock ring including a hexagonal spline, the lock ring rotatable relative to the tool bit in response to axial movement of the tool bit, during which the hexagonal body portion engages the hexagonal spline.

In some embodiments, the hexagonal spline is defined by a plurality of spiraled edges.

In some embodiments, the bit holder is positionable in a locked position, in which the hexagonal spline is misaligned with the hexagonal body portion and positioned in the non-hexagonal groove, and in which the lock ring is constrained against rotation relative to the tool bit, and positionable in an unlocked position, in which the lock ring is allowed to rotate relative to the tool bit.

In some embodiments, the bit holder further includes a body and a collar moveably coupled to the body, the collar being movable along the body to disengage the lock ring, permitting the lock ring to rotate relative to the tool bit.

In some embodiments, insertion of the tool bit into the bit holder and retention of the tool bit by the lock ring can be accomplished in a single motion with one hand.

Other features and aspects of the invention will become apparent by consideration of the following detailed description and accompanying drawings.

### BRIEF DESCRIPTION OF THE DRAWINGS

FIG. 1 is a side view of a rotary impact tool in accordance with an embodiment of the invention.

FIG. 2 is a perspective view of a bit holding device for use with the impact tool of FIG. 1.

FIG. 3 is an enlarged view of the bit holding device of FIG. 2.

FIG. 4 is a front, enlarged view of the bit holding device of FIG. 2 in a locked position.

FIG. 5 is an enlarged perspective view of the bit holding device of FIG. 4.

FIG. 6A is a front, enlarged view of the bit holding device of FIG. 2 in an unlocked position.

FIG. 6B is a front, enlarged view of the bit holding device of FIG. 2 in an locked position.

FIG. 7 an exploded perspective view of the bit holding device of FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

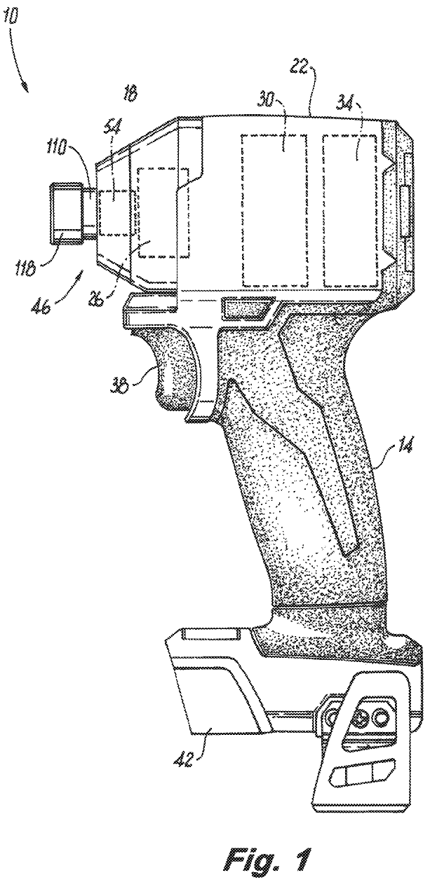

FIG. 1 illustrates a power tool in the form of a rotary impact tool or impact driver 10. The impact driver 10 includes a motor housing 22 in which an motor 34 (e.g., electric motor) is supported, a gear train 30, and an impact case 18 partially housing an impact mechanism 46 (e.g., rotary impact mechanism). The impact driver 10 further includes a handle portion 14 extending downward from the motor housing 22, a battery (not shown) removably coupled to a battery receptacle 42 located at a bottom end of the handle portion 14 for supplying power to the motor 34 when the battery is coupled to the battery receptacle 42, and a switch (e.g., a trigger switch 38) supported by the handle portion 14 that selectively electrically connects the motor 34 and the battery via a controller (including, for example, a printed circuit board having one or more microprocessors and multiple field-effect transducers) to provide power to the motor 34.

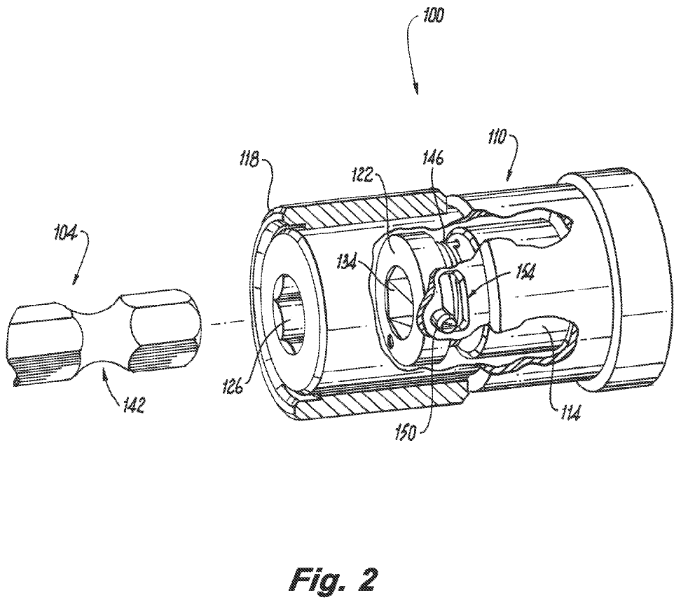

With continued reference to FIG. 1, the gear train 30 and the impact mechanism 46 are part of a drive assembly for converting a continuous torque input from the motor 34 to consecutive rotational impacts (i.e. discrete applications of torque) upon a workpiece. The impact mechanism 46 includes an anvil 54 having a bit holder or bit holding device 100 that facilitates retention and removal of a tool bit 104 (FIG. 2) from the anvil 54, as described in further detail below. The impact mechanism 46 also includes a hammer 26 configured to repeatedly strike the anvil 54, which imparts discrete applications of torque to the workpiece (e.g., a fastener). In other embodiments, the impact mechanism 46 may have other configurations, such as a hydraulic pulse mechanism, for delivering discrete applications of torque to the workpiece.

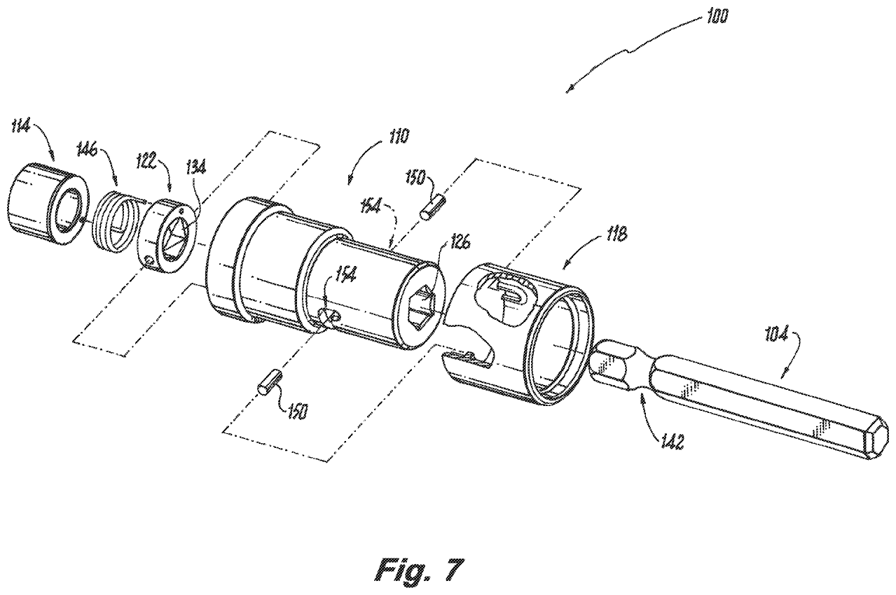

With respect to FIGS. 2-7, the illustrated bit holding device 100 is supported by the drive assembly or impact mechanism 46 and includes a body 110 having a drive element, such as a drive insert 114 configured to be rotatably driven by the anvil 54, a collar 118 surrounding the body 110 and moveable relative thereto, and a bore 126 extending centrally through the collar 118 and into the drive insert 114 for receiving the tool bit 104. In the illustrated embodiment, the bore 126 is a longitudinal bore with a hexagonal cross-section or shape.

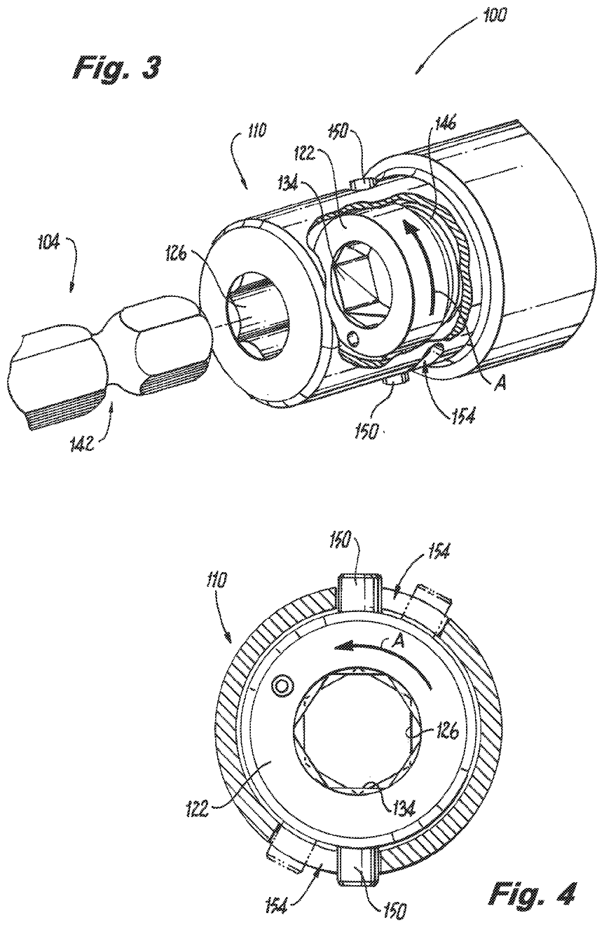

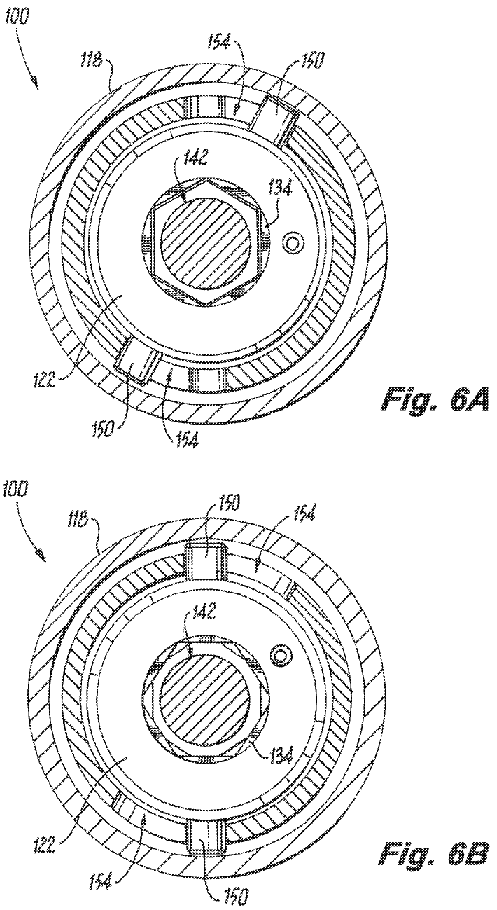

The bit holding device 100 further includes a locking element, such as a locking ring 122 supported within the collar 118 having a spiral hexagonal spline 134, which in a locking position (FIGS. 4 and 6B) of the locking ring 122, is misaligned with the edges of the bore 126 and the tool bit 104. A spring 146 is positioned between the locking ring 122 and the drive insert 114 for rotationally biasing the locking ring 122 in a clockwise direction opposite an arrow A (FIGS. 3 and 4) toward an unlocked position (FIG. 6A). To axially and rotationally constrain the movement of the locking ring 122 within the body 110, the locking ring 122 includes a plurality of posts 150 radially extending from the locking ring 122 configured to be received within corresponding L-shaped grooves 154 formed in the body 110 of the bit holding device 100.

With reference to FIG. 2, to secure the tool bit 104 within the anvil 54, a user may insert the end of the tool bit 104 into the bore 126 (e.g., longitudinal bore), using a single hand, pushing the tool bit 104 toward the drive insert 114. Continued insertion of the tool bit 104 causes the rear of the tool bit 104 to engage the spiral hexagonal spline 134, causing the locking ring 122 to rotate in the direction of the arrow A toward the unlocked position (FIG. 6A) in which the edges of the spiral hexagonal spline 134 align with the edges of the bore 126 (e.g., hexagonal cross-section) and the tool bit 104.

Referring still to FIGS. 2-7, as the tool bit 104 is fully inserted into the bore 126, a groove 142 (e.g., circumferential groove, non-hexagonal groove) in the tool bit 104 passes the collar 118 and comes into alignment with the locking ring 122. With the locking ring 122 free to rotate in the region of the groove 142, the spring 146 restores the locking ring 122 to its locking position (FIG. 4) to secure the tool bit 104 within the bit holding device 100. More specifically, the spiral hexagonal spline 134 of the locking ring 122 is misaligned with the edges (e.g., hexagonal body portion) of the tool bit 104 when in the locking position, such that the back side of the locking ring 122 blocks the edges of the tool bit 104 and prevents the tool bit 104 from being withdrawn from the bit holding device 100. Thus, the tool bit 104 may be inserted into the bore 126 of the bit holding device 100 and then retained within the bore 126 by the locking ring 122 in a single motion using only one hand.

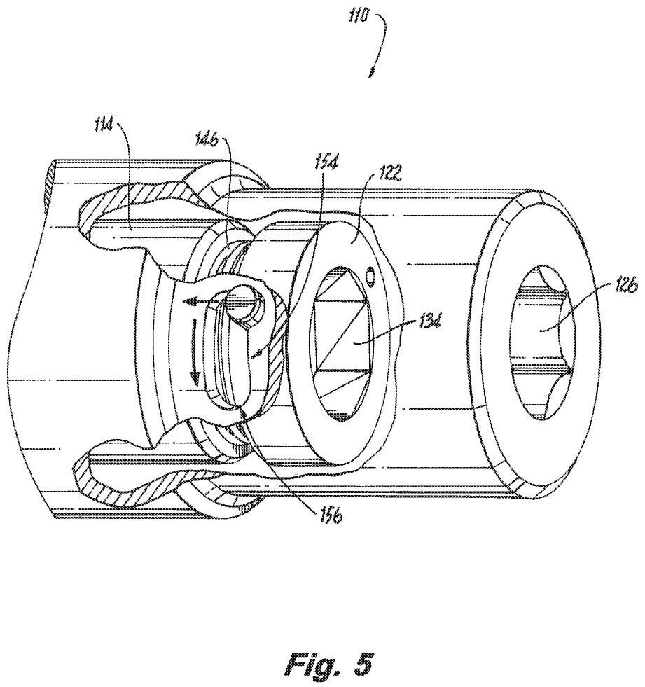

To release the tool bit 104, the user grasps the collar 118 and moves the collar 118 rearward (i.e. in an axial direction away from an open end of the bore 126). Then, while continuing to grasp the collar 118, the user rotates the collar 118 counterclockwise (in the direction of the arrow A in FIG. 3). The locking ring 122 is moved with the collar 118 against the bias of the spring 146, such that the posts 150 of the locking ring 122 travel along the L-shaped grooves 154 and toward end portions 156 of the L-shaped grooves 154 (FIG. 5). When the posts 150 reach the end portions 156 of the L-shaped grooves 154, the locking ring 122 is in its unlocked position, such that the spiral hexagonal spline 134 is re-aligned with the edges of the tool bit 104. In other words, the collar 118 may be moved to disengage the posts 150 on locking ring 122 from a stopping part of the L-shaped grooves 154, thereby permitting the locking ring 122 to rotate relative to the tool bit 104. The user may then pull the tool bit 104 from the bore 126.

In some embodiments of the bit holding device 100, a spring-biased bit ejector may be provided within the bore 126 to aid in the removal of the tool bit 104. In such embodiments, the bit ejector preferably advances the tool bit 104 far enough out of the bore 126 so that the groove 142 is not aligned with the locking ring 122. This advantageously prevents the bit holding device 100 from locking if the user releases the collar 118. As such, in such embodiments, the bit holding device 100 may be unlocked and the tool bit 104 removed from the bit holding device 100 using only a single hand.

Only requiring the user to use one hand when inserting and optionally, removing, the tool bit 104 is more efficient and convenient for the user. Additionally, only requiring the user to actuate the collar 118 when removing the tool bit 104 from the bit holding device 100 allows for faster interchangeability of the tool bits 104.

In the illustrated embodiment of the bit holding device 100, the bit holding device 100 is used with the impact driver 10 (e.g., rotary impact tool). However, in some embodiments, the bit holding device 100 can alternatively be used with other power tools, such as impact drivers, drill drivers, hammer drills, or other types of rotary power tools. In yet other embodiments, the bit holding device 100 can be utilized with any other types of tools for use with interchangeable tool bits, including non-rotary power tools and hand tools, such as multi-bit screwdrivers.

Although the invention has been described in detail with reference to certain preferred embodiments, variations and modifications exist within the scope and spirit of one or more independent aspects of the invention as described.

1. A bit holder for retaining a tool bit having a groove, the bit holder comprising:
a body defining a bore for receiving the tool bit, the bore including a first plurality of edges corresponding to an outer profile of the tool bit;
a collar movably coupled to the body; and
a lock ring supported within the collar, the lock ring including an opening having a second plurality of edges, wherein the lock ring is rotatable between a locked position in which the second plurality of edges is misaligned with the first plurality of edges and an unlocked position in which the second plurality of edges is aligned with the first plurality of edges,
wherein the lock ring is rotatable from the locked position toward the unlocked position in response to a rear end of the tool bit engaging the lock ring.

2. The bit holder of claim 1, wherein the second plurality of edges defines a spiral spline.

3. The bit holder of claim 1, further comprising a spring configured to bias the lock ring toward the locked position.

4. The bit holder of claim 1, wherein the collar is movable along the body to move the lock ring toward the unlocked position.

5. The bit holder of claim 1, wherein the rear end of the tool bit is insertable into the bore when the lock ring is in the unlocked position, and wherein the lock ring is movable from the unlocked position toward the locked position when the groove of the tool bit aligns with the lock ring to retain the tool bit within the bore.

6. The bit holder of claim 5, wherein insertion of the tool bit into the bore and retention of the tool bit by the lock ring can be accomplished in a single motion with one hand.

7. A rotary impact tool comprising:
a housing;
an electric motor supported in the housing; and
a drive assembly for converting a continuous torque input from the motor to consecutive rotational impacts upon a workpiece, the drive assembly including an anvil having a bit holder for selectively coupling a tool bit to the anvil,
the bit holder including
a body defining a bore for receiving the tool bit, the bore including a first plurality of edges corresponding to an outer profile of the tool bit,
a collar movably coupled to the body, and
a lock ring supported within the collar, the lock ring including an opening having a second plurality of edges,
wherein the lock ring is rotatable between
a locked position in which the second plurality of edges is misaligned with the first plurality of edges, and
an unlocked position in which the second plurality of edges is aligned with the first plurality of edges,
wherein the lock ring is rotatable from the locked position toward the unlocked position in response to a rear end of the tool bit engaging the lock ring.

8. The rotary impact tool of claim 7, wherein the body includes a plurality of L-shaped grooves.

9. The rotary impact tool of claim 8, wherein the lock ring includes a plurality of posts radially extending from the lock ring and received within the L-shaped grooves.

10. The rotary impact tool of claim 9, wherein the lock ring is biased toward the locked position, in which the posts are constrained from moving radially with respect to the L-shaped grooves.

11. The rotary impact tool of claim 10, wherein while in the unlocked position, the posts are configured to move radially with respect to the L-shaped grooves.

12. The rotary impact tool of claim 7, wherein one of the first plurality of edges and the second plurality of edges defines a hexagonal cross-section and extends in an axial direction.

13. The rotary impact tool of claim 12, wherein the other one of the first plurality of edges and the second plurality of edges defines a hexagonal cross-section and extends in an spiral direction offset relative to the axial direction.

14. The rotary impact tool of claim 13, wherein the other one of the first plurality of edges and the second plurality of edges are the second plurality of edge positioned on the lock ring, such that the lock ring is configured to rotate relative to the body and to the tool bit.

15. The rotary impact tool of claim 7, wherein insertion of the tool bit into the bore and retention of the tool bit by the lock ring can be accomplished in a single motion with one hand.

16. A rotary impact tool comprising:
a housing;
an electric motor supported in the housing;
an impact mechanism including an anvil and a hammer configured to repeatedly strike the anvil; and
a bit holder supported by the impact mechanism and including a lock ring configured to selectively retain a tool bit to the impact mechanism, the tool bit having a non-hexagonal groove portion formed in a hexagonal body portion, and the lock ring including a hexagonal spline,
the lock ring rotatable relative to the tool bit in response to axial movement of the tool bit, during which the hexagonal body portion engages the hexagonal spline.

17. The rotary impact tool of claim 16, wherein the hexagonal spline is defined by a plurality of spiraled edges.

18. The rotary impact tool of claim 16, wherein the bit holder is positionable in a locked position, in which the hexagonal spline is misaligned with the hexagonal body portion and positioned in the non-hexagonal groove, and in which the lock ring is constrained against rotation relative to the tool bit, and positionable in an unlocked position, in which the lock ring is allowed to rotate relative to the tool bit.

19. The rotary impact tool of claim 16, wherein the bit holder further includes a body and a collar moveably coupled to the body, the collar being movable along the body to disengage the lock ring, permitting the lock ring to rotate relative to the tool bit.

20. The rotary impact tool of claim 19, wherein insertion of the tool bit into the bit holder and retention of the tool bit by the lock ring can be accomplished in a single motion with one hand.
